(19) United States
(12) Patent Application Publication
(10) Pub. No.: US 2026/0221926 A1
(43) Pub. Date: Jul. 30, 2026

(54) STRUCTURED STABILIZERS FOR ELONGATED SUPPORT MEMBERS FOR PHOTOVOLTAIC MODULES

(71) Applicant: Watershed Geosynthetics LLC, Alpharetta, GA (US)

(72) Inventor: Carl M. Davis, III, Canton, GA (US)

(73) Assignee: Watershed Geosynthetics LLC, Alpharetta, GA (US)

(21) Appl. No.: 19/141,284

(22) PCT Filed: Dec. 21, 2023
(86) PCT No.: PCT/US2023/085428

§ 371 Date: Jun. 19, 2025

Related U.S. Application Data
(60) Provisional application No. 63/434,136, filed on Dec. 21, 2022.

(51) Int. Cl. H02S 20/20; F16F 7/10

(52) U.S. Cl. CPC H02S 20/20; F16F 7/10; F16F 2222/08; F16F 2224/0208

(57) ABSTRACT

A structured stabilizer for an elongated support member for supporting a photovoltaic module, having a first mass body and opposing second mass body interconnected by a bridge joining the mass bodies in spaced-apart relation and a passageway defined by the bridge and by the opposing mass bodies, the passageway for receiving a portion of an elongated support member for aligned seating of the stabilizer with the bridge seated on an upper surface thereof for resisting wind uplift and movement of the elongated support member while supporting the attached photovoltaic module.

### TECHNICAL FIELD

The present invention relates to apparatus and methods for mounting solar photovoltaic modules or panels to supports for an assembly for generation of electricity. More particularly, the present invention relates to apparatus and methods for stabilizing the supports to which photovoltaic modules mount for generating electricity while assisting with resistance to wind uplift forces and to movement of the supports while allowing air flow through the installed assembly. Further, particularly, the present invention relates to a structured stabilizer that seats with self-alignment on an elongated support rail for assisting with resistance to wind uplift and allowing wind flow between the structured stabilizer and the photovoltaic module that secures to the rail.

### BACKGROUND OF THE PRESENT INVENTION

Large area electrical power transmission and distribution systems interconnect generation sources of electricity to demand end-users such as residential, office, and manufacturing facilities. Various electricity generation sources include hydroelectric, fossil fuel (including coal and natural gas combustion systems), and more recently, renewable energy sources that include wind, water flow systems, and solar photovoltaic panels. Solar photovoltaic modules or panels are increasingly disposed in large tract installations for generation of electricity as a supply communicated into an electrical transmission and distribution grid.

The assembled installation of the plurality of solar photovoltaic modules, while engaged to supports, experience uplift loading forces from winds that flow over the solar energy generation site. The wind loads buffet the installed solar photovoltaic modules and supports, and the solar photovoltaic modules may experience uplift forces that the supports are to resist. To facilitate resistance to uplift forces, supports may be anchored in concrete or other ground engaging anchors.

However, concrete foundations are expensive and labor intensive for installation. Also, ground anchor devices are unsuited and not acceptable for landfill and other laydown area ground sites covered with long term impermeable closure geomembranes for restricting ambient precipitation for below ground infiltration.

Accordingly, there is a need in the art for a readily installed structured stabilizer for seating on elongated support member to which photovoltaic modules attach for generation of electricity upon exposure to ambient light, which structured stabilizer resists wind uplift forces on the supported photovoltaic modules, resists movement of the elongated support member, and allowing air flow. It is to such that the present invention is directed.

### BRIEF SUMMARY OF THE INVENTION

The present invention meets a need in the art by providing a structured stabilizer comprising a first mass body; a second mass body; and a bridge joining the first mass body and the second mass body in spaced-apart relation, and a passageway defined by the bridge and by the opposing first mass body and second mass body, said passageway for receiving a portion of an elongated support member rail for aligned seating of the structured stabilizer with the bridge on an upper surface of the elongated support member.

In another aspect, the present invention provides a photovoltaic energy system for installation on a surface, comprising a pair of elongated support members for positioning in space-apart relation on a surface, for supporting a photovoltaic module thereon for generating solar energy; and a structured stabilizer for attaching to at least one of the elongated support member for resisting wind uplift and movement of the elongated support member relative to the surface. The structured stabilizer comprises a first mass body and a second mass body joined in spaced-apart relation by a bridge. A passageway defined by the bridge and by the opposing first mass body and second mass body, for receiving a portion of the elongated support member for aligned seating of the structured stabilizer with the bridge seated on an upper surface of the elongated support member.

Objects, advantages, and features of the present invention will become apparent upon a reading of the following detailed description in conjunction with the drawings.

### BRIEF DESCRIPTION OF THE DRAWINGS

FIG. 1 illustrates in perspective view a structured stabilizer according to the present invention for seating on an elongated support member that supports a photovoltaic module.

FIG. 2 illustrates in perspective view an installation of a plurality of photovoltaic modules secured to spaced-apart elongated support members that receive the structured stabilizer for resisting wind uplift forces on the photovoltaic modules.

FIG. 2A is a detailed cross-sectional view taken on line 2A-2A of FIG. 2 illustrating a gap for lateral air flow through the assembled elongated support member supporting the photovoltaic module and with the structured stabilizer seated thereon for resisting wind uplift and movement of the elongated support member.

FIG. 3 illustrates in perspective detailed view of FIG. 2 showing a structured stabilizer seated on an elongated support member.

FIG. 4 illustrates in perspective detailed view of FIG. 2 showing a pair of axially aligned structured stabilizers seated on an elongated support member.

FIG. 5 illustrates in perspective exploded view an alternate embodiment of the structured stabilizer assembled from separate members.

FIG. 6 illustrates in perspective cut-away view an alternate embodiment of the structured stabilizer defining hollow vessels for receiving a mass material.

### DETAILED DESCRIPTION

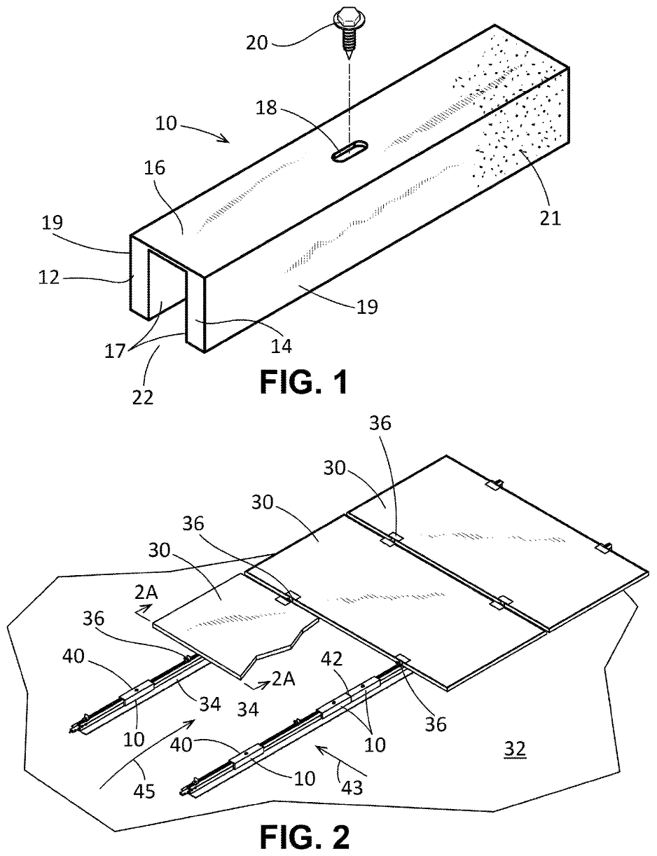

With reference to the drawings in which like parts have like identifiers, FIG. 1 illustrates in perspective view a structured stabilizer 10 according to the present invention for seating on an elongated support member that supports a photovoltaic module. The structured stabilizer comprises a first mass body 12 and a second mass body 14 in spaced-apart relation and interconnected by a bridge 16. The first mass body 12 and the second mass body 14 have respective opposing inner surfaces 17 and outward lateral extents 19. The bridge 16 joins the first mass body 12 and the second mass body 14 in spaced-apart relation.

The bridge 16 in the illustrated embodiment extends from an upper portion of the mass bodies 12, 14. In the illustrated embodiment, the bridge 16 extends between the outward extents 19 of the mass bodies. In an alternate embodiment, the plate sits between the inner surfaces of the mass bodies with an upper surface co-planar with an upper surface of the opposing mass bodies. The bridge 16 defines in the illustrated embodiment an opening 18 intermediate the opposing laterally outward extents 19, preferably centrally medial, for receiving a fastener 20 therethrough.

The bridge 16 and the opposing first mass body 12 and second mass body 14 define a longitudinal passageway 22. In the illustrated embodiment, the passageway 22 is open opposing the bridge 16, for receiving a portion of an elongated support member for aligned seating of the stabilizer 10 with the bridge seated on an upper surface of the elongated support member as discussed below. The fastener 20 secures the stabilizer 10 to the elongated support member. To resist corrosion during use of the structured stabilizer 10 in outdoor environments, the stabilizer may include an anti-corrosion coating 21, such as galvanizing or other anti-corrosion coating material for metals.

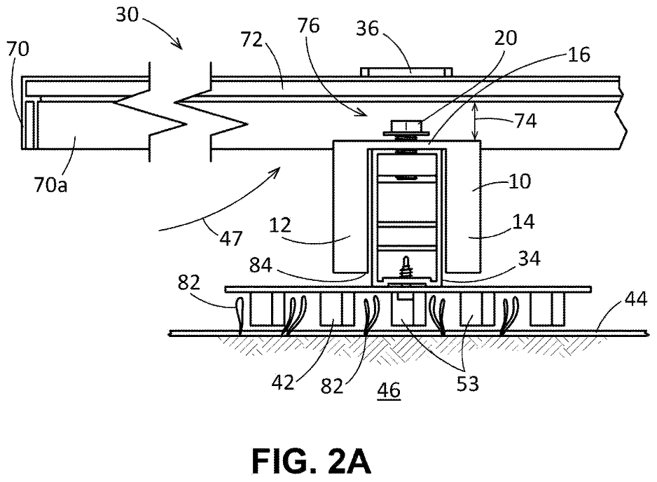

The structured stabilizer 10 in use assists resistance to wind uplift of planar photovoltaic modules secured to elongated support members in a solar electricity energy generation system 28 located at a site. FIG. 2 illustrates in perspective view the solar electricity energy generation system 28 having a plurality of photovoltaic modules 30 installed over a surface 32 to a pair of spaced-apart elongated support members 34. The elongated support members 34 are extruded tubes or rails having opposing upper and lower surfaces and opposing sides. A plurality of the support members coaxially align to form a line of supports for holding the photovoltaic modules, which line is spaced from a second line. In the illustrated embodiment, the elongated support member 34 has an upper side defined by opposing inwardly extending flanges 35. A plurality of clips 36 secure the photovoltaic modules 30 to the elongated support members 34.

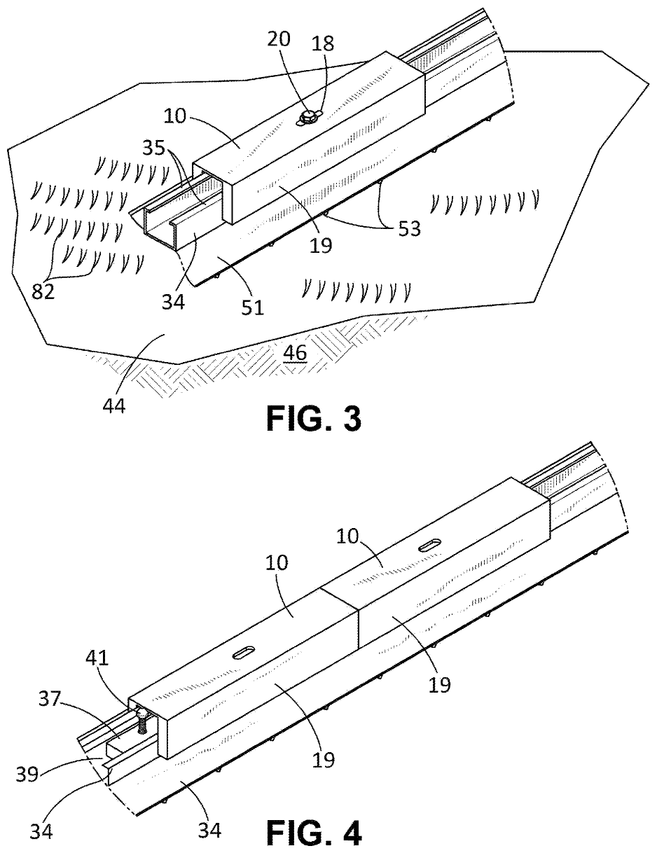

As shown in FIG. 3, the rails 34 in the illustrated embodiment attach to an attaching strip 51 from which a plurality of laterally and longitudinally spaced projections, feet, stubs, or fingers 53 extend for engaging, for example, a tufted geosynthetic cover system 44 overlying a ground surface 46 which may include an impermeable geomembrane, or directly to a ground surface. Other anchor devices may be used to secure the rails 34 to the ground; for example, an in-ground anchor seated below the ground surface in a greenfield that does not have a requirement to divert water and to restrict below ground inflow of ambient environment water.

One or more of the structured stabilizer 10 seat on the elongated support members 34. The passageway 22 of the stabilizer 10 receives the elongated support member 34 inwardly between the opposing first mass body 12 and second mass body 14. The upper surface of the elongated support member 34 abuts in contact with a bottom interior surface of the bridge 16. The fastener 20 passes through the opening 18 and engages the elongated support member 34 to secure the stabilizer 10 in place.

FIG. 2 illustrates a first installation 40 of a sole structured stabilizer 10 and a spaced-apart second installation 42 of multiple axially aligned structured stabilizers 10 on the elongated support members 34. The stabilizers 10 dispose a mass of the first and second mass bodies 12, 14 on opposing sides of the longitudinal axis of the elongated support members 34. The stabilizers 10 resist wind uplift forces on the photovoltaic modules 30. Wind flow may pass longitudinally 45 under the photovoltaic module 30 between the spaced-apart support members 34. Further, the thickness of the bridge (height between the top surface of the support member 34 and the top surface of the bridge) leaves a gap between the top surface of the bridge and the bottom surface of the solar panel in the photovoltaic module 30. This gap allows air flow laterally 47 through the photovoltaic module support structure.

FIG. 2A is a detailed cross-sectional view on line 2A-2A in FIG. 2 illustrating a gap 76 for lateral air flow 47 through the assembly of the elongated support member 34 supporting the photovoltaic module 30 with the structured stabilizer 10 seated on the elongated support member for resisting wind uplift and movement of the elongated support member. The photovoltaic module 30 includes a C-shaped frame 70 (end side) and 70a (lateral side) that support a glass solar panel 72. A bottom edge of the frame 70 seats on the upper surface of the elongated support member 34. The clip 36 (partially illustrated in FIG. 2A) has an extending flange that overlies an upper edge of the frame 70 and connects to the support member 34 to secure the photovoltaic module 30 to the support member. The upper surface of the plate 16 is spaced 74 from a bottom surface of the solar panel 72 to leave a lateral air flow gap 76 therebetween for lateral air flow 47. FIG. 2A illustrates the support member 34 connected to attaching strip 40 seated on the tufted geosynthetic cover 44 having a plurality of tufts 82 of synthetic yarn as simulated blades of grass.

FIG. 3 illustrates in perspective detailed view of FIG. 2 showing the first installation 40 with the structured stabilizer 10 seated on the elongated support member 34.

FIG. 4 illustrates in perspective detailed view an alternate embodiment showing two axially aligned structured stabilizers 10 seated on the elongated support member 34. In this alternate embodiment, the bridge 16 does not include the opening 18. Rather, a block 37 slides into an open channel 39 of the elongated support member 34, for example underneath the opposing flanges. A stop member 41, such as a threaded fastener, engages the block 37. Alternatively, the threaded fastener 41 is used without the block 37 but rather directly engages to the elongated support member 34. The stop member 41 abuts a downhill edge of the structured stabilizer 10. The stop member 41 resists longitudinal sliding movement of the structured stabilizers 10. The stop member 41 may be inserted into a side of the support member or as illustrated into an upper side. The fastener 41 may be a bolt and cross plate. The cross plate defines an opening that threadably receives the bolt. The cross plate inserts between the opposing flanges of the support member 34 in the illustrated embodiment and contacts an inner surface of opposing flanges when the threaded fastener engages an opening in the cross plate. Alternatively, the fastener 41 may be a self-tapping or self-drilling screw for engaging the support member.

The structured stabilizer 10 provides a structural mass component received by the elongated support member 34 for providing a lower center of gravity relative to the ground surface, assisting with resisting wind uplift, and allowing for through wind flow of air longitudinally 45 between the elongated support members 34 and the bottom surface of the solar panel 72 or laterally 47 through the gap between the top surface of the plate 16 and the bottom surface of the solar panel 72.

The passageway 22 conforms in cross-section to the cross-section of the elongated support member 34 for closely fitting of the structured stabilizer 10 to the support member. With the upper surface of the elongated support member 34 received into the passageway 22, the structured stabilizer 10 self-aligns against the inner side walls 17 of the opposing mass bodies 12, 14. The structured stabilizers 10 attach in selected position to the elongated support members 34 with the fasteners 20. The structured stabilizers 10 provide mass for increased stability of the elongated support members 34 that connect to and support the planar photovoltaic modules 30. The structured stabilizers 10 provides increased factor of safety as well as over-all increased structural stability for the solar photovoltaic module energy generation system installed overlying a surface.

This structured stabilizers 10 are readily easily transported to a site at which a solar photovoltaic electric generation system is being installed. The solar photovoltaic electric generation system with elongated rails disposed in spaced-apart relation for supporting solar photovoltaic modules 30 secured with clips 36. The bridge 16 cooperatively seats on an upper surface of the elongated support member 34. Subsequently, another solar photovoltaic module 30 installs overlying the structured stabilizers 10 as illustrated in FIG. 2. The structured stabilizers 10 may be manufactured in selected lengths to accommodate sufficient engineering design mass requirement yet dimensionally narrow between the opposing extents 19 so as to not disrupt airflow under the solar photovoltaic panels 30.

While the illustrated embodiment depicts the mass bodies 12, 14 in rectangular shape, the mass bodies may be irregular in shape such as scrape metal pieces, angle iron members, bar stock, rebar, or other heavy dense metal members that can be welded together or machined to define an opening for fasteners to secure the members together. The outward extents 19 may define a curved or irregular surface. Further, the edges of the distal extent of the mass bodies 12, 14 at the open edge may be chamfered or beveled for accommodating the receiving placement of the structured stabilizers 10 onto the elongated support members 34.

As an illustrative, non-limiting example, an exemplary solar energy generation site has sloped ground surfaces and reasonably determined wind loads. The wind load may be based on observed winds over time. Based on engineering evaluations, a stabilizing structure 10 of 20 pounds is determined sufficient for resisting movement of the elongated support member 34 and resisting wind uplift. The elongated support member 34 in the illustrative example is an elongate rail having a height of 2 inches and width of 1½ inches. The stabilizing structure 10 has the passageway 22 of 1⅝ inches wide and 1½ inches high, for closely receiving the rail. FIG. 2A illustrates a slight gap 84 between the rail 34 and the inner face of the mass bodies 12, 14. The determined mass may be provided by the first and second mass bodies 12, 14 of 9 pounds each and the bridge 16 of 2 pounds. The stabilizing structure 10 may be constructed as a cast iron molding. Alternatively, the stabilizing structure 10 may be welded elongated metal members such as scrap metal plates. The mass bodies 12, 14 each may be elongated plates having a width of 1 inch, a height of 1½ inches, and a length sufficient to have a mass of 9 pounds. The bridge 16 may similarly be a metal plate of a width sufficient to overlie the upper surfaces of mass bodies that are spaced 1⅝ inches apart and a length sufficient to provide a mass of 2 pounds. The top plate 16 is sufficiently thick to interconnect the opposing mass bodies 12, 14 for structural rigidity but leaves a vertical gap between the upper surface of the top plate and the bottom surface of the solar panel to allow air flow.

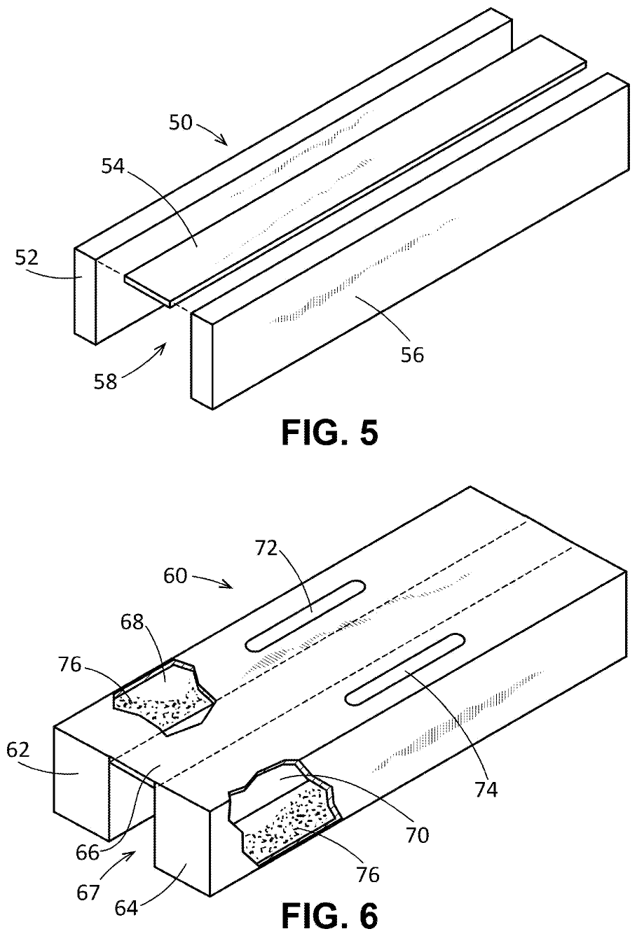

FIG. 5 illustrates in perspective exploded view an alternate embodiment 50 of the structured stabilizer assembled from separate members 52, 54 as opposing mass bodies interconnected by a plate 56. The separate members 52, 54, 56 may be scrap metal, metal plates, or mass materials, and welded together to define the passageway 58 for receiving the elongated support member 34 when installed at a photovoltaic generation site.

The longitudinal passageway 22 of the structured stabilizer 10 is sized to closely hug the elongated support member 34 while disposing the mass bodies 12, 14 on opposing sides and the bridge 16 extends minimally above the upper surface of the elongated support member 34 for not impeding air flow under the solar photovoltaic modules 30 from the sides. The open face of the passageway 22 facilitates placement of the structured stabilizer 10 with self-aligning receiving of the elongated support member 34 to abut the bridge 16 against the upper surface of the elongated support member while not blocking or obstructing air flow in the space below the solar photovoltaic modules and between the elongated support members.

The mass of each structured stabilizer 10 may be tailored to the engineering design needs of the particular solar electricity generation installation by including additional structured stabilizers 10, or during the manufacturing process by either changing the length of the structured stabilizers or adjusting the thickness of the opposing first and second mass bodies 12, 14 that define opposing left and right masses lateral of the elongated support member. In an alternate embodiment, mass plates may be attached to the distal extents 19 for increasing the mass of the structured stabilizers 10.

The structured stabilizer 10 may be cast or molded such as with cast iron, and galvanized to provide the surface coating 21 for resisting corrosion from outdoor use. Alternatively, the structured stabilizer 10 may be assembled from separate mass pieces as shown in FIG. 5 for the opposing mass bodies 12, 14 (52, 54) and interconnecting bridge 16 (56), which pieces are welded together. The separate pieces may be elongated metal pieces, elongated railroad tie members cut to length, rebar members, scrap metal plates or members.

FIG. 6 illustrates in perspective cut-away view an alternate embodiment 60 of the structured stabilizer defining opposing hollow vessels 62, 64 interconnected by a bridge 66. The opposing vessels 62, 24 cooperatively with the bridge 66 define a passageway 67 for seating on the support member 34. The vessels 62, 64 each define an interior cavity 68, 70 and each define a respective opening 72, 74 (selectively closable by a cap (not illustrated)). The vessels 62, 64 receive a mass material 76 through the openings 72, 74 to fill the respective cavity 68, 70. The mass material may be cement, sand, a cement-sand mixture, lead buckshot, bb pellets, water or other fluid, or mass particles. The amount of the mass material 76 can be selectively inserted based on the particular site engineering requirements for resisting wind-uplift and movement of the support member 34. The structured stabilizer 60 may be a molded plastic housing or may be separate housings or vessels that interconnect together by the bridge 66. In an alternate embodiment the structured stabilizer is a flexible bladder that overlies the support member 34 to position respective first and second portions on opposing sides of the support member. The bladder receives mass material through a closable opening.

The foregoing has disclosed various embodiments of the structured stabilizer apparatus and method for stabilizing elongated support members supporting attached solar photovoltaic modules in the solar electricity generating system for resisting wind uplift and movement of the elongated support member. The illustrated embodiments are not limiting, and variations, changes, and alternative structured stabilizers may readily be achieved based on the foregoing disclosure within the scope of the claims for such invention appended hereto.

What is claimed is:

1. A structured stabilizer for an elongated support member, comprising:
a first mass body;
a second mass body;
a bridge joining the first mass body and the second mass body in spaced-apart relation;
a passageway defined by the bridge and by the opposing first mass body and second mass body, said passageway for receiving a portion of an elongated support member for aligned seating of the stabilizer with the bridge seated on an upper surface of the elongated support member.

2. The structured stabilizer as recited in claim 1, wherein the bridge is coplanar with a respective upper surface of the opposing first mass body and second mass body.

3. The structured stabilizer as recited in claim 1, wherein the bridge defines an opening for receiving a fastener therethrough for securing the structured self-aligning stabilizer to the elongated support member.

4. The structured stabilizer as recited in claim 1, further comprising a stop member for engaging the elongated support member proximate a downward end of the structured stabilizer.

5. The structured stabilizer as recited in claim 4, wherein the stop member comprises a threaded fastener.

6. The structured stabilizer as recited in claim 1, further comprising an anti-corrosion coating on an exterior surface.

7. The structured stabilizer as recited in claim 1, wherein the first and second mass bodies and interconnecting bridge comprise a cast iron body.

8. The structured stabilizer as recited in claim 1, wherein the first and second mass bodies and interconnecting bridge comprise separate members connected together.

9. The structured stabilizer as recited in claim 1, wherein the first and second mass bodies define hollow vessels for each receiving a mass material.

10. The structured stabilizer as recited in claim 9, wherein the mass material comprises a cementatious material, a cement and sand mixture, a sand, or metal particles.

11. A photovoltaic energy system, comprising:
a pair of elongated support members for positioning in space-apart relation on a surface, for supporting a photovoltaic module thereon for generating solar energy; and
a structured stabilizer for attaching to at least one of the elongated support member for resisting wind uplift and movement of the elongated support member relative to the surface, comprising:
a first mass body;
a second mass body;
a bridge joining the first mass body and the second mass body in spaced-apart relation;
a passageway defined by the bridge and by the opposing first mass body and second mass body, said passageway for receiving a portion of an elongated support member for aligned seating of the stabilizer with the bridge seated on an upper surface of the elongated support member.

12. The photovoltaic energy system as recited in claim 11, wherein the bridge defines an opening for receiving a fastener therethough for securing the structured self-aligning stabilizer to the elongated support member.

13. The photovoltaic energy system as recited in claim 11, further comprising a stop member for engaging the elongated support member proximate a downward end of the structured stabilizer.

14. The photovoltaic energy system as recited in claim 13, wherein the stop member comprises a threaded fastener.

15. The photovoltaic energy system as recited in claim 11, further comprising an anti-corrosion coating on an exterior surface.

16. The photovoltaic energy system as recited in claim 11, wherein the first and second mass bodies and interconnecting bridge comprise a cast iron body.

17. The photovoltaic energy system as recited in claim 11, wherein the first and second mass bodies and interconnecting bridge comprise separate members connected together.

18. The photovoltaic energy system as recited in claim 11, wherein the first and second mass bodies define hollow vessels for each receiving a mass material.

19. The photovoltaic energy system as recited in claim 18, wherein the mass material comprises a cementatious material, a cement and sand mixture, a sand, or metal particles.
